(19) United States
(12) Patent Application Publication
(10) Pub. No.: US 2025/0333264 A1
(43) Pub. Date: Oct. 30, 2025

(54) PROCESS SYSTEM FOR CARRYING OUT A PROCESS ON A WORKPIECE, AND METHOD FOR CARRYING OUT A PROCESS ON THE WORKPIECE

(71) Applicant: MANZ AG, Reutlingen (DE)

(72) Inventors: Martin FREUNDT, Esslingen (DE); Arne DITSCHER, Wesenberg (DE)

(21) Appl. No.: 18/866,500

(22) PCT Filed: May 3, 2023
(86) PCT No.: PCT/EP2023/061689

§ 371 Date: Nov. 15, 2024

(30) Foreign Application Priority Data
May 17, 2022 (DE) 10 2022 112 359.6

(51) Int. Cl. B65H 85/00; B65H 9/10

(52) U.S. Cl. CPC B65H 85/00; B65H 9/10; B65H 2301/331; B65H 2301/36; B65H 2801/03

(57) ABSTRACT

A process unit for the printing of a workpiece, with a process mechanism for the printing of the workpiece in an infeed direction in a process area, with a relative positioning device for the relative positioning of the workpiece and the process mechanism in a transverse direction, and an infeed device for the feed of the workpiece to the process mechanism, whereby the infeed device is designed to feed the workpiece to the process mechanism in a circulation process more than once along at least one orbital path.

The subject of this invention is a process unit for the application of a process to a workpiece with the features generically defined in claim 1. The invention also refers to a method for the application of the process to the workpiece.

In printing done on components, especially with ink jet print heads, a distinction is made between two different print methods. In the one, so-called single-pass methods are used, in which the component is fully printed in a single pass beneath the print head. The printed image is thus generated in a single run, with each drop from the print head defining one area of it, so that the correct positioning of the drop on the one hand is much more important while, on the other, it is possible to depict sharper contours, since there is no averaging done by means of statistical drop positioning. A disadvantage of the single-pass method is that the width of the print heads has to correspond to the width of the print zone, which in turn means that a good deal of printing technology needs to be installed.

The other method is the multi-pass method, In which the printed image is gradually built up in several print passes which generate the desired image serially. Here, only part of the volume to be printed is printed on each pass, or the surface is only printed in part. An advantage of the multi-pass method is that the geometrical errors that occur when the drops are transferred to the surface on successive passes and the incremental printing of the image as a whole vanish by being statistically averaged, so that the fault effects disappear in our optical perception of the whole and a more even impression of the image arises, in spite of the fact that neither the sharpness/precision nor the productivity of single-pass printing are actually attained.

One of the tasks of this invention is to propose a process unit for the application of a process to a workpiece, and a method for the application of that process to the workpieces. The application distinguishes itself by having a new principle of operation.

This task is solved by means of a process unit with the features of claim 1, and by means of a method with the features of claim 12. Preferred or advantageous design forms of the invention are to be seen in the sub-claims, the descriptions that follow and the figures attached.

The subject of the invention is a process unit for the application of a process to a workpiece. In particular, this can be a measurement process and/or a manufacturing process. A combination of the two is also possible. The measurement process can for example be an image-assisted process based on a camera. The process is designed to be contact-free. The manufacturing process may for example be a print treatment, a laser treatment or some such.

The workpiece is designed as an occasional workpiece. A workpiece can also be a finished product which is measured, documented and/or inspected via the measurement process.

The process unit has a process mechanism for the application of the process to the workpiece. The process mechanism may in particular have one or more preparation modules for application of the process. The preparation modules preferably have a range of application that is limited in the transverse direction. In a printing operation. the range may be specified by a dimension of a print head as a preparation module; in a laser treatment it may be specified by the process area of a laser head as a preparation module. In an image-assisted measurement process, it may be specified by a visibility range and/or the measurement area of a camera. In particular, the process application is designed as an application of a process which is extended in the transverse direction of the process unit.

The process is applied to the workpiece in an infeed direction, with the workpiece being moved in the direction of infeed relative to the process mechanism and thus processed. The process is applied in a process area of the process unit. In particular, the process area is positioned under the process mechanism and/or is congruent to it.

The process unit has a relative positioning device for the relative positioning of the workpiece and the process mechanism in a transverse direction. In particular, the transverse direction is oriented vertical to the direction of infeed, With the relative positioning device, the workpiece can be positioned relative to the process mechanism in the transverse direction. The application of the process to the workpiece extends in particular longitudinally and transversely. In particular, the application areas of the preparation modules, limited transversely, are each smaller than the maximum area and/or the application area of the process mechanism in the transverse direction.

The process unit has an Infeed device to feed the workpiece to the process mechanism, i.e. to the process area. The feed device will be designed to feed the workpiece to the process mechanism more than once in a circulation process along at least one orbital path and in particular to transport it along the process mechanism for projecting. In particular, the workpiece travels the orbital path in the process area at least twice, so that the process mechanism can apply the process to it more than once, i.e. at least twice. It is thus possible that on different orbits the workpiece has a different, i.e. defined position in the transverse direction relative to the process mechanism. Preferably, the process mechanism is positioned longitudinally stationary in the process unit, especially during process application.

The infeed device forms a clamp for the workpiece, in which the workpiece remains gripped during the two or more journeys along the orbital path and is thus, each time, positioned correctly in the process area for the process application and/or positioned within defined limits. The workpiece is held in the clamp in the correct position and/or a constant position, for example with a positive fit.

In terms of the Invention, the proposal is for the workpiece and, in particular, other workpieces to be fed through in the same direction relative to the stationary process mechanism and subsequently transported past the process mechanism along the orbital path, in the circulation process but outside the process area, so as to be ready again for a second or further run relative to the process mechanism. That enables the process mechanism to perform the application of the process on the workpieces almost without a break, provided that they can be returned rapidly enough on the orbital path. In the multiple process applications in the transverse direction, the process application areas on the workpiece may be positioned adjacent to one another. In the process, particularly in a printing operation, these process application areas are referred to as single-pass areas. Alternatively or additionally, in the multiple process applications in the transverse direction, the process application areas on the workpiece may be positioned with at least some overlap. In the process, particularly in a printing operation, these process application areas are referred to as multi-pass areas.

In one possible configuration of the invention, the relative positioning device is designed to move the process mechanism transversely so as to reach the relative transverse position of the workpieces in the process mechanism. This configuration has the advantage that there only needs to be an actuator for the relative positioning device in one position, indeed there only needs to be one actuator, i.e. for shifting the process mechanism.

In an alternative design of the invention, the relative positioning device is designed to move the workpiece transversely so as to reach the relative position of the workpiece and the process mechanism. Preferably, the process mechanism is designed to be stationary in the transverse direction, especially when there is a very high and possibly almost uninterrupted flow of workpieces. In the process area, this has the advantage that the workpieces are already in the desired relative position in the transverse direction relative to the process mechanism, so that if necessary it is only the process parameters of the process mechanism that need to be adjusted to suit the workpiece. This can usually be done very quickly, so that the output rate of the process unit can be very high. If, by contrast, the process mechanism needs to be moved transversely, and if the output rate is high and the process application to the workpieces very individual, it may need to be offset for each workpiece, so that it will at least be necessary to maintain sufficient distance between one workpiece and the next to allow the process mechanism to be positioned in the transverse direction in a timely manner.

In a preferred constructional configuration of the invention, the infeed device has at least one workpiece holder as a clamp to hold the workpiece in the circulation process. The workpiece holder ensures that the workpiece is held in a defined position, i.e. the correct position, and that it can still be fed to the process mechanism in the correct and/or defined position after completion of the orbital path. For flexible use of the process unit, the workpiece holder may be designed to be replaceable and/or the infeed device to have a workpiece retainer to hold the workpiece holder. This way, the Infeed device can easily be converted for other workpieces.

In a preferred further developed version of the invention, the infeed device has at least one shuttle, which carries the workplace holder. The shuttle may also have more than one workpiece holder. The shuttle is positioned on the workpiece retainer described above.

In a preferred further developed version of the invention, the shuttle can be fed in to and/or ejected from the circulation process along the orbital path, especially at the ends of it. This way, a fully processed workplace can be ejected from the orbital path on the shuttle and a new shuttle with a new workpiece fed in. When a shuttle is used, the infeed device can be loaded with workpieces very rapidly.

As long as the workpiece or workplace holder is held on the shuttle, the process can be applied to the workpiece in several orbits, whereby the individual process applications can be realized very precisely vis à vis one another in terms of their positioning.

In a preferred alternative of the invention, a workpiece holder with a component, the shuttle or the component itself can be fed into and/or ejected from the circulation process along the orbital path, especially at the ends of it. This way, a workpiece can be ejected from the orbital path after process application and a new one fed in. Here too, the workpiece is always held in the correct position in the workpiece holder, even if there are several runs.

Alternatively or additionally, the infeed device has at least one relay section, which is designed as an infeed section for feeding in and/or an ejection section for ejection of the workpiece holder, component, workpiece retainer and/or shuttle etc. The relay section is positioned outside the orbital path and/or extends it, so that feeding in and/or ejection do not block it. For example other workpieces can be transported and processed on the orbital path while a workpiece is being fed in and/or ejected in the relay section. In particular, the relay sections can be positioned and/or arranged as extensions to the orbital path in the direction of infeed and/or longitudinally.

The workpiece in the relay section is fed into the infeed device in the correct position and/or ejected in such a way that it is positioned correctly in the relay section of the Infeed device, especially for orbit or when coming out of orbit.

In a preferred constructional further developed version of the invention, the relative positioning device is designed as an adjusting axis for the transverse relocation of the workpiece. With the adjusting axis, the workpiece can be positioned very precisely in the transverse direction. The adjusting axis travels together with the workpiece, i.e. on the shuttle. The adjusting axis can relocate the workpiece directly or indirectly. In direct relocation, it acts on the workpiece. In indirect relocation it can relocate the workpiece holder directly or indirectly. In direct relocation the adjusting axis acts directly on the workpiece holder. In indirect relocation it can relocate the workpiece retainer and/or the shuttle.

In a preferred constructional further developed version of the invention, the infeed device has at least one first orbit device with a linear infeed axis to move the workpiece holder and/or workpiece and/or shuttle and/or workpiece retainer longitudinally and/or in the direction of infeed on the orbital path. The use of this linear infeed axis ensures that the workpiece can be moved in the transverse direction via the workpiece holder and/or shuttle and/or workpiece retainer longitudinally, both at a precise infeed velocity and with a low time tolerance. This enables highly precise application of the process to the workpiece. Preferably, the first orbit device and/or each orbit device forwards exactly one workpiece retainer and/or exactly one workpiece holder. To increase the flow, there could be several orbit devices of this kind, each of which transports one workpiece retainer or one workpiece holder. The respective workpieces could be fed to the process mechanism in quick succession or even without interruption.

As regards the linear infeed axis, the relay section may be designed as an extension of it, whereby the extension goes beyond the linear axis area of the orbital path. especially in the direction of infeed and/or longitudinally. For example, a linear infeed axis of this kind has an extension section, which especially in the direction of infeed and/or longitudinally has a length of at least one workpiece, preferably at least two workpieces and in special cases at least three workpieces so as to form the relay section. This makes it possible to feed in and eject the workpiece etc. outside the orbital path.

In a preferred further developed version of the invention, the first orbit device has an actuator to manipulate the workpiece, which is designed in such a way that, on a process run, it positions the workpiece holder and/or workpiece and/or shuttle and/or workpiece retainer along the orbital path in the process areas, while on a return run along the orbital path, especially in the direction opposite to the print run, it positions them in a return zone outside the process area. This ensures that there cannot be a collision with workpieces following in circulation.

As regards the formation of the actuator, for example, the workpiece can be shifted by it vertically or laterally and is thus transported back, for example, beneath or above the process mechanism and/or beneath or above the process area. In that case, for example, the actuator is designed as a height-adjusting linear axis, in such a way as to assist in the precise positioning of the workpiece relative to the process mechanism.

Alternatively, the workpiece can be swiveled away by the actuator, so that it is not transported through the process area on the return run. In this case the actuator is designed as a swivel axis, designed to assist in the precise positioning of the workpiece relative to the process mechanism.

The actuator can be designed to be active, so as to be operated for example electrically, pneumatically and/or hydraulically. Or it may have a passive design, being operated mechanically for example by forced routing.

In a preferred further developed version of the invention the workpiece in circulation is always in the correct position. It is held in a defined position and defined orientation above the process application on two or more runs, and/or transported between the shuttle and the process module in relation to it and/or to the process mechanism and optional adjustment systems. The position is defined by a sensor system with low or no tolerance, with frictional locking, for example a vacuum gripper, with positive locking, for example a device or component holder, or by axis-controlled positioning of the workpiece during orbit, for example via a cross-adjustment axis and/or sensors that are suitable for the adjustment of the desired workpiece position.

It is particularly preferable for the process mechanism to have various different process characteristic areas in the transverse direction. These process characteristic areas can be distinguished by various different processes. For example, measurement and/or manufacturing processes can be implemented in the transverse direction. Having said that, the process characteristic areas may vary on account of differences in the process parameters. These different process characteristic areas can be realized via different process modules.

It is particularly preferable for the process unit to be designed as a print unit for the printing of the workpiece.

The printing may be decorative, such as an image, pattern or some other surface print. Alternatively, it may be functional, for example to apply electrically conductive and/or electrically active layers to the workpiece.

The workpiece can be of any size. For example, it may be designed to be small, with a maximum dimension of less than 5 cm, or large, with a maximum dimension of more than 1 m. If the components are flat and even, the component may be designed with a surface larger than 0.1 m², larger than 2 m², or even larger than 2.5 m², designed up to 3 m². Alternatively or additionally, the component may be smaller than 10 m², smaller than 7 m², or smaller than 5 m².

The print unit has a printing device as a process mechanism for a printing operation and/or printing process as the application of a process to the workpieces. The printing device may have one or more print heads as process modules. The printing device, in particular each of the print heads, has print jets which issue liquid printing ink. The printing ink is designed for example as a colored ink, and/or as a functional ink, which is for example electrically conductive and/or active. The printing process is designed as an ink jet printing process, for example DOD (drop on demand) or with electrostatic print heads.

One particularly major disadvantage of the multi-pass process is that a print head is guided over a component for printing, then braked, turned sideways and then guided back over the component in the opposite direction. On the one hand, this means that for each journey of the print head over the component the print head needs to change direction, and on the other hand that the print head needs to be moved so far over the component that auxiliary equipment attached to the print head, such as curing lamps for the ink, also reach a position in which they are wholly above the component. Consideration should also be given to the fact that after each journey the print head first needs to be braked, and then accelerated after changing direction, before it can be moved back over the component at a constant speed. In particular, the print unit will be suitable and/or designed for multi-pass printing of the workpiece.

The infeed device and in particular the constant clamping of the workpiece during the orbits ensure that the critical change of position in the transverse direction takes place within defined limits and/or can be performed precisely on the scale of the print resolution. This, for example, is something that a conveyor belt cannot do, because the positional fault effects would be too strong.

Another aspect of the invention refers to a method of process application with the process unit, as described above, whereby the latter is designed, in a circulation process, to feed the workpiece to the process mechanism more than once along at least one orbital path and to process it. At least one multi-pass area will be processed, i.e. imprinted on the workpiece.

Consideration should be given in general to the fact that in processes of all kinds, in particular the printing process, both the single-pass process and the multi-pass process have advantages of their own, though these advantages lie in the different layouts of the respective units. In particular, under optional inclusion of the workpiece holder, shuttle, workpiece retainer, adjusting axis and/or linear infeed axis, the workpiece is positioned relative to the process mechanism with a high degree of precision and moved in such a way that in this configuration the process unit also makes high-quality single-pass areas possible on the workpiece. That in turn means that a hybrid variant is also possible, which enables a combination of single-pass and multi-pass on a single component surface of the workpiece.

In the print process, image areas or image structures, which are realized with the characteristics of single-pass printing, and areas or overlapping areas which are printed with the characteristics of multi-pass printing. This makes it possible to use the quality characteristics of both processes selectively in the printed image, so as to tailor quality vs. productivity purposively to specific print requirements.

In the transverse direction for example, it is possible for different color areas, resolution areas for the print resolution, printing ink areas, drop sizes etc. to be positioned or operated with appropriately different settings.

Alternatively or additionally, in the transverse direction, in particular between the process characteristic areas, one or more process gap areas, i.e. print gap areas, can be positioned in the process mechanism, so that process-free areas are specified in the transverse direction.

Thus the workpiece can be transported through the respective print characteristic area/process characteristic area required for the process in several runs, in particular the printing operation. The process characteristic area is selected by the relative positioning of the workpiece or process head in the transverse direction.

As an optional addition, at least one multi-pass area and at least one single-pass area can be processed, i.e. printed on the workpiece. For example these can be positioned adjacently and/or laterally offset in the transverse direction, i.e. a certain distance apart. However, it is also possible for the process unit to process Le. print a layer structure, with the latter having various different layers, for example with different process results, i.e. printing inks, and the different layers having at least one single-pass area and at least one multi-pass area.

In a preferred configuration of the process, one of the process characteristic areas has a first process characteristic and another, second process characteristic which deviates from the first. In the multi-pass area a printing operation will be carried out with the first and the second process characteristic. Thus the first and second process characteristics do not need to be made available by the process unit on a common process path in the direction of shift; instead, in multi-pass operation, the multi-pass area can be processed first with the first process characteristic, the workpiece then offset transversely, so that it can be printed in the second process characteristic area with the second process characteristic in the same multi-pass area.

For example, the first and/or second process characteristic is designed as a print characteristic, whereby the latter includes a drop size selection for the printing ink. The respective drop size selection includes a limited number of drop sizes. For example, the drop size is specified in a 2-bit value, so that the first print characteristic includes three drop sizes and the second print characteristic also three drop sizes, each of the same printing ink. But the drop sizes of the first and second print characteristics are designed differently. This way, recourse can be had in the multi-pass area to a greater number of different drop sizes, namely six in this example. This makes it possible, for instance, to realize a gray scale with a higher resolution as regards contrast, because a greater number of drop sizes are available.

Alternatively or additionally, as well as or in addition to the influences of the dosing technique, the printing speed and/or the run time per pass can be varied too.

Other features, advantages and effects of the invention can be seen in the ensuing description of a preferred design example and the attached figures. These show:

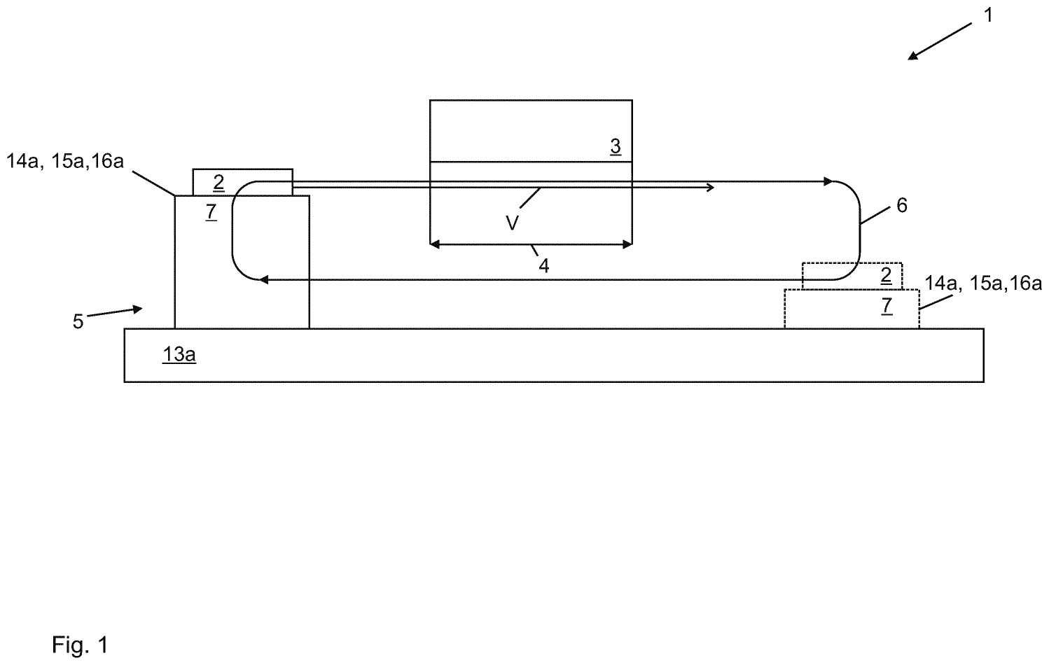

FIG. 1: Schematic diagram of a process unit designed as a print unit as a design example of the invention in side view;

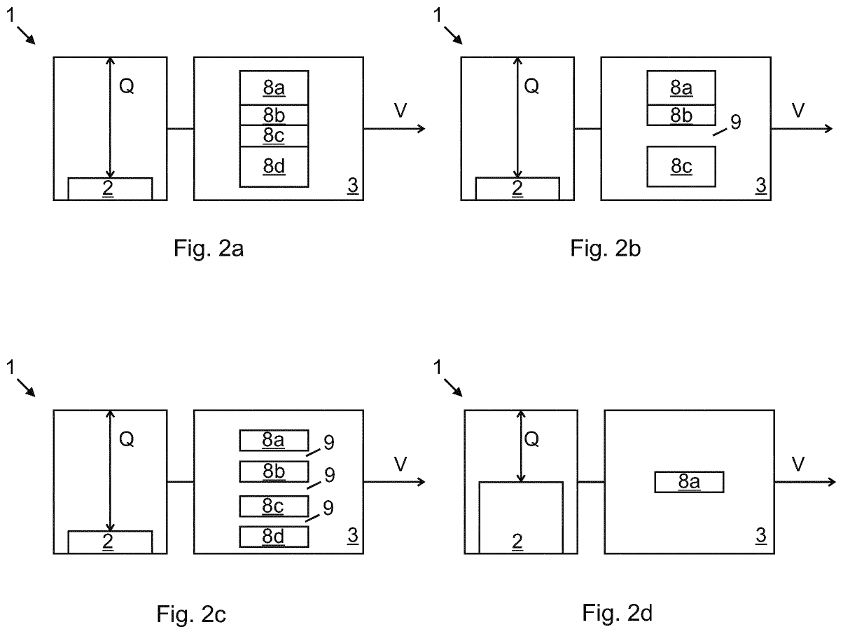

FIGS. 2a, b, c, d: The process unit from FIG. 1 in top view;

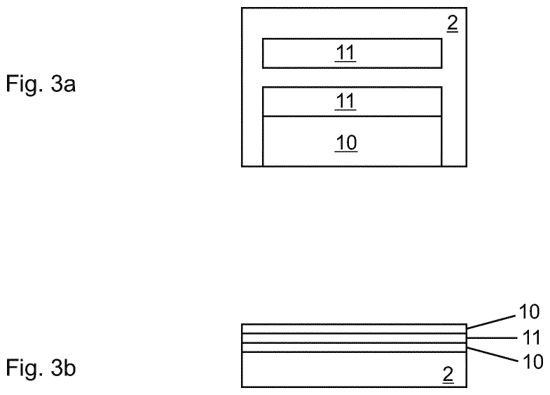

FIGS. 3a, b: Various different printed workpieces from the process unit In the above figures.

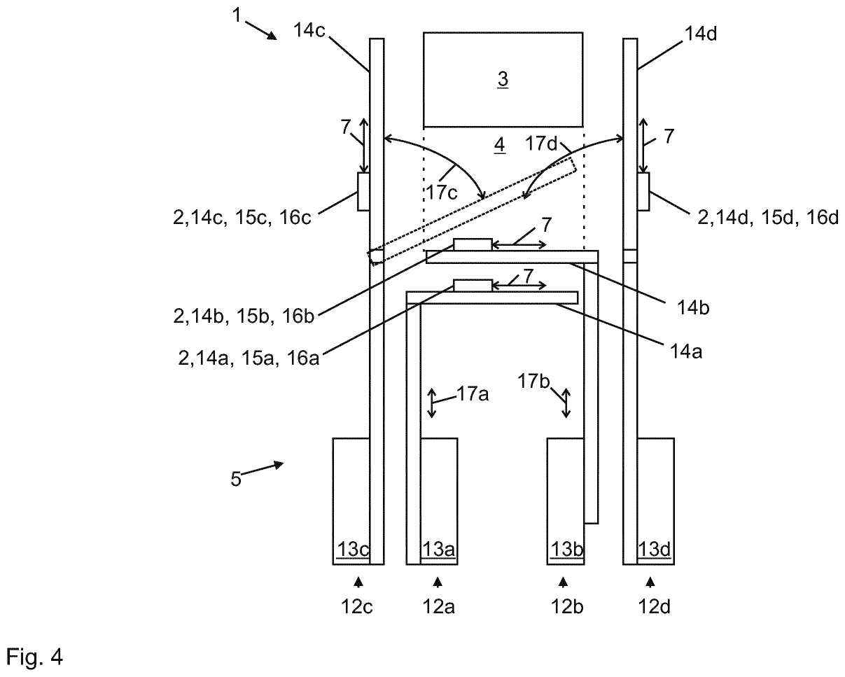

FIG. 4: Schematic top view, seen from the front, of a design example of the process unit in the above figures.

In a schematic block diagram, FIG. 1 shows a process unit 1 designed as a printing device for the printing of a workpiece 2 as the application of a process to the workpiece 2. The process unit 1 has a process mechanism 3 designed as a printing device, which enables the workpiece 2 to be printed. The printing device is designed in particular as an ink jet printing device and/or works on the ink jet principle. The printing device uses printing ink, which is applied to the workpiece 2 in the printing process and can be designed for example as a colored ink, for generating printed images and/or décors, or as a functional ink, for example for creating electrically conductive and/or active layers or other functional layers on the workpiece 2 as a print operation.

In the process unit 1, the workpiece 2 is transported in an infeed direction V in a process area 4 designed as a printing area of the process mechanism 3, and printed.

To initiate the movement of the workpiece 2 in the direction of infeed V, the process unit 1 has an infeed device 5 designed as a print infeed device, which transports the workpiece 2 in the process area 4 In this design example beneath the process mechanism 3. The workpiece 2 should be transported at least twice through the process area 4 and/or along the process mechanism 3 for processing and/or printing. For that reason, the Infeed device 5 is designed to feed the workpiece 2 in a circulation process along a track 6 in the process mechanism 3. The orbital path 6 is designed as an enclosed orbital path 6 to enable the circulation to take place.

FIG. 1 shows the workpiece 2 twice. It is shown with a solid line in the direction of infeed V for a print run as a process run, and with a dashed line after the process mechanism 3, to Illustrate that the same workpiece 2 is transported back along the orbital path 6 on a return run in the opposite direction to the process run as a print run. On the return run the workpiece 2 is transported back outside the process area 4 along the orbital path 6. That makes it possible to feed in the workpiece 2 more than once, i.e. at least twice in the circulation process of the process mechanism 3 for a printing operation without any risk of collision.

The process unit 1 has a relative positioning device 7, which is designed for the relative positioning of the workpiece 2 and the process mechanism 3 in a transverse direction Q. The transverse direction Q is angled, oriented more specifically vertical to the direction of infeed V. In the design example shown, the relative positioning device 7 is designed to shift the workpiece 2 in the transverse direction Q, whereby the process mechanism 3 is designed to remain stationary in the transverse direction Q during the print process. The shift of the workpiece 2 in the transverse direction Q is performed outside the process area 4.

FIGS. 2a to 2d each show a schematic top view of the process unit 1 in the area of the process mechanism 3. The workpiece 2 is moved into a desired position by the relative positioning device 7 in the transverse direction Q and then transported in the direction of infeed V beneath the process mechanism.

That means it is possible for the workpiece 2 to pass through various different process characteristic areas 8a, b, c, d as print characteristic areas of the process mechanism 3 and be treated there. If areas of the workpiece 2 are processed more than once on more than one journey through the printing area 4, the procedure corresponds to a multi-pass method and multi-pass areas are formed, However, it is also possible for the workpiece 2 to be printed once only, so that a single-pass method is implemented and a single-pass area formed on the workpiece. Furthermore, it is possible that on the first run zebra crossings are first applied as process areas and the unprinted and/or unprocessed stripes printed or processed in a further run and/or orbit. This can also be done with the same print characteristics and/or process characteristics.

The process characteristic areas 8a, b, c, d can be designed as different areas on a common process module, e.g. as a print head. Alternatively or additionally, the process characteristic areas 8a, b, c, d can be allocated to several process modules, especially print heads. Each process characteristic area 8a, b, c, d can have a process module of its own allocated to it, i.e. a print head in the process mechanism 3.

For example, the process characteristic areas 8a, b, c, d may differ by having different printing inks, different resolutions or other jet parameters and/or print head parameters. Thanks to the possibility of positioning the workpiece 2 relative to the process mechanism 3 in the transverse direction Q, it is possible to select a process characteristic area 8a, b, c, d which has process characteristics such as those needed for the print operation.

FIG. 2a shows a design example in which the process mechanism has 3 or 4 process characteristic areas 8a, b, c, d, which are juxtaposed gaplessly in the transverse direction Q.

FIG. 2b shows a design example in which the process mechanism 3 includes fewer process characteristic areas 8a, b, c and Instead has a process gap area 9 in the transverse direction Q, which is positioned between two process characteristic areas 8b and 8c. If the workpiece 2 is transported through the process gap area 9, there cannot be any processing in that transverse area or, in particular, any printing. The transverse area can be printed and/or processed in a subsequent orbit.

FIG. 2c shows a design example in which the process characteristic areas 8a, b, c, d in the transverse direction Q are at a distance from one another such that in each case there is a process gap area 9 between them. That makes it possible to process i.e. print a zebra crossing first, and subsequently to process/print the unprocessed/unprinted areas in at least one further orbit.

FIG. 2d shows a design example in which the dimension of workpiece 2 in the transverse direction Q is greater than that of the sole process characteristic area 8a. Another advantage of the print unit 1 can be seen in this figure, because the processing of the broader workpiece 2 does not require a process mechanism 3 which—as is usual in the single-pass method—has at least the same process width, i.e. print width; Instead, a process mechanism 3 with a much smaller process area can be selected, in the transverse direction Q. And when we consider, for example, that the print heads of the process mechanism 3 are a cost driver in the manufacture of the process unit 1, this possibility of a method with several orbits leads to a marked reduction in the costs of the unit.

In other design examples, the print width and/or the process area of the process mechanism 3 in the transverse direction can be designed to be narrower than the workpiece 2, and the process mechanism 3 can either be gapless and/or feature one or more process gap areas 9 or print gap areas.

FIG. 3 shows a model top view of the workpiece 2, in which one multi-pass area 10 and two single-pass areas 11 are processed on the workpiece 2 by the process unit 1. One of the single-pass areas 11 is positioned at a distance from the multi-pass area 10 and/or the other single-pass area.

FIG. 3 shows a schematic cross section through the workpiece 2, with the single-pass areas 11 and the multi-pass areas 10 designed as layers one above the other. In this way a functional printing of the workpiece 2 can be implemented, while the selection of multi-pass areas 10 and single-pass areas 11 is subject to the technical necessities.

In a schematic top view seen from the front, FIG. 4 shows the process unit 1 with the process mechanism 3 and the infeed device 5. The infeed device 5 has a plurality of orbit devices, in this example four: 12a, b, c, d. Each of the orbit devices 12a, b, c, d has a linear infeed axis 13a, b, c, d, to move the workpiece 2 in the infeed direction V for the process run and in the opposite direction for the return run.

Each of the orbit devices 12a, b, c, d has a workpiece retainer 1a, b, c, d, on which the respective workpiece 2 is positioned / positionable. Preferably, the workpiece 2 is positioned in a workpiece holder 15a, b, c, d, in order to get it into the correct position for more than one journey in the circulation process. In particular, the workpiece 2 is positioned in the workpiece holder 15a, b, c, d with a positive fit and/or fixedly and/or immovably in the transverse direction Q and/or the direction of shift V. The workpiece holder 15a, b, c, d can be positioned directly on the workpiece retainer 14a, b, c, d. Alternatively, the workpiece holder 15a, b, c, d is on a shuttle 16a, b, c, d, which is positioned detachably on the workpiece retainer 14a, b, c, d, so that the respective shuttle 16a, b, c, d can simply be fed in to and ejected out of orbit to speed up the change of workpiece.

The orbit devices 12a, b, c, d each have an actuator 17a, b, c, d to manipulate the workpiece 2 and/or the workpiece retainer 14a, c, b, d, so that on the process run along the orbital path 6 the workpiece 2 and/or the workpiece retainer 14a, b, c, d are positioned in the printing area 4, while on a return run along the orbital path 6 in the opposite direction to the process run they are positioned outside the process area 4.

On the orbit devices 12a, b, the actuators 17a, b are designed as linear axes for height adjustment. The infeed linear axes 13a, b are positioned opposite one another, so that the workpiece retainers 14a, b can work vertically offset in orbit.

The actuators 17c, d of the orbit devices 12c, d are designed as swivel axes which can swing the workpiece retainer 14c, d out of the collision zone of the process area 4 on the return run. The four workpiece retainers shown 14a, b, c, d can thus be transported one after the other in any order through the process area 4 and brought back on the return run with the workpiece 2 along the orbital path 6 without any risk of collision.

Each of the orbit devices 12a, b, c, d has exactly one workpiece retainer 14a, b, c, d. The relative positioning device 7 can be designed in any way in the orbit devices 12a, b, c, d, and can shift the workpiece retainer 14a, b, c, d, shuttle 16a, b, c, d, or workpiece holder 15a, b, c, d, or directly shift the workpiece itself.

In other design examples the process unit 1 shown can carry out other process applications such as a measurement process, laser processes, with the process modules being designed accordingly as measurement modules, manufacturing modules etc. and the . . . process characteristic area 8a, b, c, d as measurement areas, manufacturing areas etc.

### LIST OF REFERENCE NUMBERS

1 Print unit
2 Workpiece
3 Printing device
4 Printing area
5 Infeed device
6 Orbital path
7 Relative positioning device
8a, b, c, d Print characteristic areas
9 Print gap area
10 Multi-pass area
11 Single-pass area
12a, b, c, d Orbit devices
13a, b, c, dInfeed linear axes
14a, b, c, dWorkpiece retainer
15a, b, c, dWorkpiece holder
16a, b, c, dShuttle
17a, b, c, dActuator

1-15. (canceled)

16. A process unit for application of a process to a workpiece, comprising: a process mechanism for and/or on the workpiece in an infeed direction in a process area;
a relative positioning device for relative positioning of the workpiece and the process mechanism in a transverse direction; and an in feed device configured to feed the workpiece to the process mechanism, wherein the in fee device is configured to feed the workpiece to the process mechanism more than once along at least one orbital path in a circulation process.

17. The process unit according to claim 16, wherein the relative positioning device (7) is configured to move the process mechanism in the transverse direction in order to reach the relative position of the workpiece and the process mechanism.

18. The process unit according to claim 16, wherein the relative positioning device is configured to move the workpiece in the transverse direction to reach the relative position of the workpiece and that the process mechanism.

19. The process unit according to claim 16, wherein the infeed device has at least one workpiece holder configured to hold the workpiece in the circulation process.

20. The process unit according to claim 19, wherein the infeed device has a shuttle that carries the workpiece holder.

21. The process unit according to claim 18, wherein the relative positioning device is configured as an adjusting axis for shifting the workpiece in the transverse direction.

22. The process unit according to claim 19, wherein the infeed device has at least one first orbit device with a linear infeed axis to move the workpiece holder and/or the workpiece in the longitudinal and/or infeed direction of the orbital path.

23. The process unit according to claim 22, wherein the orbit device has an actuator to manipulate the workpiece and/or the workpiece holder, wherein the actuator is configured so as to position the workpiece holder and/or the workpiece in the process area on a process run along the orbital path, while on a return run along the orbital path, in an opposite direction to the process run, the actuator positions the workpiece holder and/or the workpiece in a return zone outside the process area.

24. The process according to claim 16, wherein the process mechanism has various different process characteristic areas in the transverse direction.

25. The process unit according to claim 16, wherein the process mechanism has process gap areas in the transverse direction.

26. The process unit according to claim 16, wherein the workpiece is always held in a correct position in the circulation process.

27. A method for application of a process to workpieces, comprising the steps of: providing a process unit according to claim 16; utilizing the process unit to feed the workpiece in a circulation process to the process mechanism more than once along at least one orbital path; and, processing the workpiece in the process mechanism.

28. The method according to claim 27, including processing laterally adjacent multi-pass areas and single-pass areas and/or overlying multi-pass layer zones and single-pass layer zones on the workpiece.

29. The method according to claim 28, wherein one process characteristic area has a first process characteristic while another process characteristic area has a second process characteristic that deviates from the first process characteristic, wherein the processing is carried out with both the first and the second process characteristic in the multi-pass area.

30. The method according to claim 27, The method according to claim 27, wherein the process application is a print operation.
